(19) United States
(12) Patent Application Publication
(10) Pub. No.: US 2004/0011185 A1
(43) Pub. Date: Jan. 22, 2004

(54) Snare gate for drum

(76) Inventor: Norihiko Ishimatsu, Hamamatsu-shi (JP)

Correspondence Address: DICKSTEIN SHAPIRO MORIN & OSHINSKY LLP, 41st Floor, 1177 Avenue of the Americas, New York, NY, 10036-2714, US

(21) Appl. No.: 10/614,890

(22) Filed: Jul. 9, 2003

(30) Foreign Application Priority Data
Jul. 12, 2002 (JP) 2002-204515

(51) Int. Cl. G10D 13/02

(52) U.S. Cl. 84/415

(57) ABSTRACT

This invention is adapted to a snare drum having a snare that is stretched under tension above a snare head, wherein both ends of the snare is protected by snare gates, which are fixed to prescribed positions opposite to each other across the snare head stretched under tension across an opening of a hollow cylinder. Each of the snare gates is constituted by a slender horizontal plate, and a pair of legs fixed to a hoop that is fixed to circumferential ends of the opening of the hollow cylinder, wherein it is reinforced by ribs that are formed by inwardly bending side edges of the legs so that the ribs are formed integrally together with the legs. Thus, it is possible to increase the overall strength of the snare gate by using ribs without increasing the thickness of a material plate used therefore.

### BACKGROUND OF THE INVENTION

1. Field of the Invention

This invention relates to snare gates that are attached to hoops of snare drums or hoops of other drums having snares such as marching drums and bass drums, for example.

2. Description of the Related Art

Snare drums have non-striking heads (namely, backside drumheads or snare heads) and striking-side drumheads (simply referred to as drumheads), wherein snares are arranged for both of the drumheads, or they are selectively arranged for either the backside drumheads or the striking-side drumheads. The snares can be controlled at positions so as to be spaced apart from the drumheads or to be brought into contact with hoops for supporting the drumheads under tension, wherein when they are brought into contact with the drumheads, vibrations of the drumheads are transmitted to the snares to cause the snare drums to produce relatively light tone colors such as sprinkling-like sounds; in other words, the snares are controlled at positions to actualize special sound effects on the drums, an example of which is disclosed in Japanese Examined Utility-Model Publication No. Sho 58-50372.

FIG. 3 shows the exterior appearance of a conventional snare drum, which is illustrated upside down so that a snare is arranged on a backside drumhead (i.e., a snare head), wherein reference numeral 1 designates a snare drum, 2 designates a drum body (i.e., a hollow cylinder), 3 designates a backside drumhead (i.e., a snare head), 4 designate hoops (or clamp frames) that are attached to openings of the hollow cylinder 2, 5 designates lugs, 6 designates clamp bolts for interconnecting together the hoops 4 and the lugs 5, and 7 designates a snare.

The snare 7 is fixed to the snare head 3 between opposite ends of the hoop 4 in such a way that both ends thereof are fixed to plates 9 by solder, and plates 9 are respectively interconnected with snare strainers 11, which are attached to opposite sides of the exterior circumference of the hollow cylinder 2 via bands 10. The snare strainers 11 control the snare 7 so as to be spaced apart from the snare head 3 or to be brought into contact with the snare head 3. When the snare drum 1 is not used, a roller 12 for supporting the band 10 is moved upwards so that the snare 7 is certainly spaced apart from the snare heads 3. When the snare drum 1 is used, a user (or a player) operates a lever 13 to pull down the roller 12 so that the snare 3 is brought into contact with the snare head 3 under tension applied thereto. When the user strikes the drumhead with a drumstick and the like while the snare 7 is brought into contact with the snare head 3, a vibration originally applied to the drumhead is transmitted to the snare head 3, from which it is transmitted to the snare 7. Thus, it is possible to produce a relatively light tone color such as a sprinkling-like sound on the snare drum 1; that is, it is possible to realize a special sound effect on the drum.

Normally, snare gates 14 are attached to the hoop 4 of the snare drum 1 in connection with the snare strainers 11, and they are arranged to protect the hoop 4 and the snare 7 from being damaged due to an external force unexpectedly applied thereto. FIG. 4 shows an example of the snare gate 14, which is formed in a reverse L-shape in side view by carrying out bending and folding processes on a metal plate. Specifically, the snare gate 14 of FIG. 4 is constituted by a slender horizontal plate 14A, and a pair of legs 14B that are formed by bending both ends of the horizontal plate 14 downwards and at approximately right angles from the exterior thereof, and these legs 14B are fixed to prescribed positions of the hoop 4 so that the horizontal plate 14A is arranged just above the plate 9. Incidentally, the snare gate 14 is not necessarily provided independently of the hoop 4; that is, conventionally-known snare gates can be formed integrally together with the hoop by die casting, for example.

To improve the exterior appearance, the snare gate 14 is made of a thin metal plate whose thickness is relatively small, and the legs 14B are each attached to the hoop 4 in a direction perpendicular to a diameter direction of the hoop 4. During transportation, when the horizontal plate 14A and/or the legs 14B are forcibly hit a wall, a post, or a desk, the legs 14B are deformed in shape or inwardly collapse towards the drumhead. This is a problem to be solved by the present invention.

### SUMMARY OF THE INVENTION

It is an object of the invention to provide a snare gate for a drum which can be increased in strength against external forces without increasing the thickness thereof, so that the snare gate can be reliably prevented from being deformed or collapsed due to the external force unexpectedly applied thereto.

This invention is adapted to a snare drum having a snare that is stretched under tension on or above a snare head, which is arranged opposite to a drumhead actually struck with a drumstick with respect to a hollow cylinder, wherein both ends of the snare are protected by snare gates, which are fixed to prescribed positions opposite each other across the snare head stretched under tension across an opening of the hollow cylinder. Each of the snare gates is constituted by a slender horizontal plate and a pair of legs fixed to a hoop that is fixed to circumferential ends of the opening of the hollow cylinder on which the snare head and snare are arranged, wherein each of them is reinforced by ribs that are formed by inwardly bending side edges of the legs so that the ribs are formed integrally together with the legs. Other than ribs, it is possible to form beads by carrying out plastic working on the legs as well as on the horizontal plate as necessary.

Thus, it is possible to increase the overall strength of the snare gate by using ribs without increasing the thickness of a material plate used therefor. Hence, it is possible to reliably prevent the snare gates from being bent or collapsed due to an external force unexpectedly applied thereto.

### BRIEF DESCRIPTION OF THE DRAWINGS

These and other objects, aspects, and embodiments of the present invention will be described in more detail with reference to the following drawings, in which:

FIG. 1 is a perspective view showing a snare gate adapted to a snare drum and its related parts arranged in connection with a part of a hoop;

FIG. 2A is a plan view of the snare gate in accordance with another embodiment of the invention;

FIG. 2B is a front view of the snare gate observed from the exterior in a diameter direction of the snare drum;

FIG. 3 is a perspective view showing the exterior appearance of a conventional snare drum having a snare stretched under tension by snare strainers covered by snare gates; and

FIG. 4 is a perspective view showing an example of a conventionally-known snare gate.

### DESCRIPTION OF THE PREFERRED EMBODIMENTS

This invention will be described in further detail by way of examples with reference to the accompanying drawings.

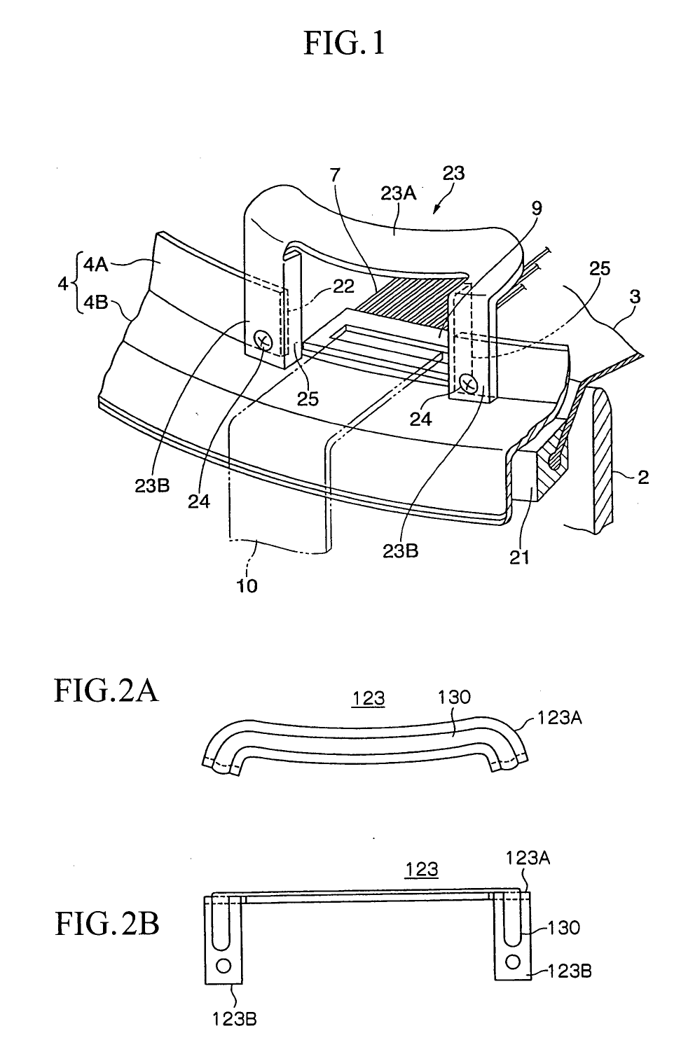

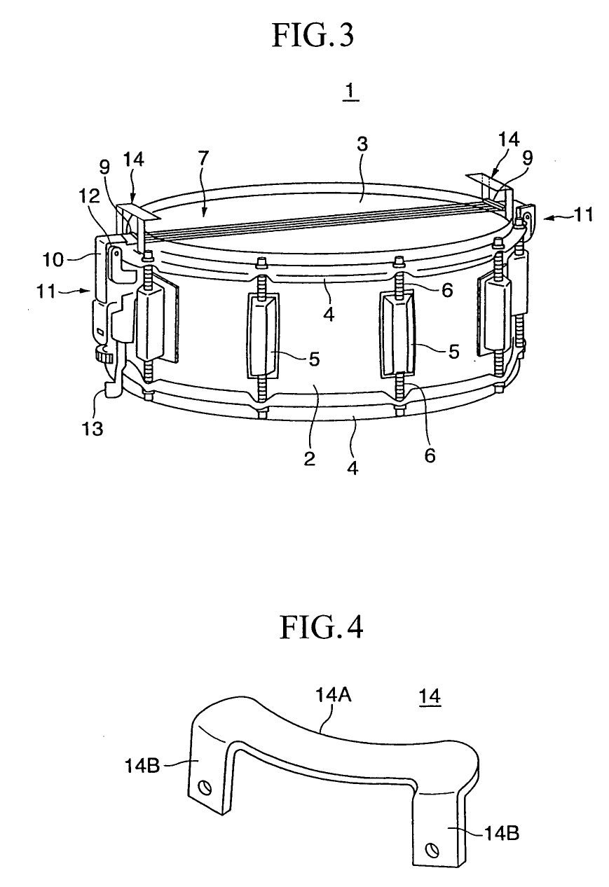

FIG. 1 is a perspective view showing a snare gate for use in a snare drum in accordance with a preferred embodiment of the invention, wherein parts identical to those shown in FIG. 3 are designated by the same reference numerals; hence, the detailed description thereof will be omitted as necessary. Similar to the conventional snare drum 1 shown in FIG. 3, a snare gate of the present invention is applied to a snare drum in which a snare (not shown) is attached to a snare head (arranged opposite a surface drumhead to be struck with a drumstick) across a hollow cylinder, wherein the basic structure of the snare drum applicable to the present embodiment is identical to that of the conventional snare drum 1.

In FIG. 1, reference numeral 21 designates a ring head frame that holds exterior circumferential ends of a snare head 3 and is attached to the exterior circumference of a hollow cylinder 2, wherein when a hoop 4 is operated to press the ring head frame 21, the snare head 3 is stretched across the hollow cylinder 2 under tension.

The hoop 4 is constituted by a cylindrical portion 4A whose diameter is slightly greater than the diameter of the hollow cylinder 2, and a press portion 4B that is integrally interconnected with the ends of the cylindrical portion 4A in proximity to the hollow cylinder 2 and is formed in a rough L-shape in cross section. An opening portion 22 is formed at a prescribed position of the cylindrical portion 4A in correspondence with a plate 9 of a snare 7 and allows a belt 10 to pass therethrough, whereby a snare gate 23 is fixed so as to interconnect together both ends of the opening portion 22 of the cylindrical portion 4A of the hoop 4. The press portion 4B for pressing the ring head frame 21 is interconnected with lugs 5 via clamp bolts 6 (see FIG. 3).

The snare gate 23 as a whole is formed in roughly a reverse L-shape by carrying out bending and folding processes on a metal plate, and it is constituted by a slender horizontal plate 23A and a pair of legs 23B that is formed by bending both ends of the horizontal plate 23A downwards and at approximately right angles from the exterior thereof. The legs 23B of the snare gate 23 are respectively fixed to both ends of the opening portion 22 of the cylindrical portion 4A of the hoop 4 by screws 24. Each of the legs 23B is roughly formed in an L-shape in cross section, so that a rib 25 is integrally formed thereon. Herein, the ribs 25 of the legs 23B are bent inwardly and at approximately right angles in opposite directions (or towards the snare head 3). The snare gate 23 of the present embodiment is basically similar to the foregoing conventional snare gate 14 in material and thickness of the material plate thereof, whereas it is characterized by integrally forming the aforementioned ribs 25 thereon.

That is, the snare gate 23 is characterized in that the ribs 25 are formed at approximately right angles to the horizontal plate 23A and the legs 23B, and the legs 23B are reinforced by the ribs 25 to increase the overall strength of the snare gate 23 in the thickness direction. Therefore, it is possible to reliably prevent the snare gate 23 from being collapsed when the legs 23B are unexpectedly bent inwardly due to an external force applied to the horizontal plate 23A and the legs 23B, which eliminates the necessity for increasing the thickness of the material plate in order to increase the overall strength of the snare gate 23.

In addition, the ribs 25 are located inside of the legs 23B, by which it is possible to prevent materials from being unnecessarily wasted.

FIG. 2A is a plan view showing a snare gate 123 in accordance with another embodiment of the invention, and FIG. 2B is a front view of the snare gate 123 that is observed from the exterior in a diameter direction of a snare drum (not shown).

This embodiment is characterized in that beading processes are carried out on a center portion of the surface of a horizontal plate 123A in the width direction as well as center portions of the surfaces of legs 123B in the width direction, both of which are elastically deformed so that surfaces are partially projected to form beads 130, each having a hemispherical shape in cross section, which are used as ribs.

According to this embodiment, the snare gate 123 is reinforced not only in the legs 123B but also in the horizontal plate 123 by the beads (or ribs) 130. Therefore, even when an external force is applied to the horizontal plate 123A in the thickness direction, it is possible to reliably prevent the horizontal plate 123A from being unexpectedly bent. In addition, the beads (or ribs) 130 having circular shapes do not hurt a user's hand when holding the horizontal plate 123A of the snare gate 123 during transportation.

This invention is not necessarily limited to the aforementioned embodiments; therefore, it is possible to make various modifications in the design of snare gates adapted to snare drums and the like within the scope of the invention. For example, it is possible to integrally form ribs on the side edges of the horizontal plate 23A of the snare gate 23 shown in FIG. 1 by a bending formation, whereby it is possible to further increase the overall strength of the snare gate 23. Alternatively, it is possible to integrally form the foregoing ribs 25 (shown in FIG. 1) along the interior edges of the legs 123B of the snare gate 123 shown in FIGS. 2A and 2B, whereby it is possible to further increase the overall strength of the snare gate 123.

As described heretofore, this invention has a variety of effects and technical features, which will be described below.

(1) A snare gate adapted to a snare drum is designed in such a way that each of the legs is roughly formed in an L-shape in cross section so as to increase the strength thereof, whereby it is possible to reliably prevent the legs of the snare gate from being unexpectedly bent due to an external force applied thereto.

(2) Ribs are integrally formed on the center portions of the legs of the snare gate, and it is unnecessary to produce the ribs independently of the legs by using other materials in welding; therefore, it becomes easy to produce the snare gate.

(3) In addition, ribs can be integrally formed on a horizontal plate of the snare gate by processing (e.g., plastic working), whereby it is possible to further increase the overall strength of the snare gate.

(4) Ribs can be constituted by beads, whereby it is possible to improve the exterior appearance of the snare gate.

As this invention may be embodied in several forms without departing from the spirit or essential characteristics thereof, the present embodiments are therefore illustrative and not restrictive, since the scope of the invention is defined by the appended claims rather than by the description preceding them, and all changes that fall within metes and bounds of the claims, or equivalents of such metes and bounds, are therefore intended to be embraced by the claims.

What is claimed is:

1. A snare gate for a snare drum, comprising:
a horizontal plate; and
a pair of legs for supporting the horizontal plate, wherein the legs are fixed to prescribed positions of a hoop, which is fixed to circumferential ends of an opening of a hollow cylinder of the snare drum, and wherein side edges of the legs are respectively bent inwardly to form ribs, each roughly having an L-shape in cross section, thus reinforcing the legs.

2. A snare gate for a snare drum, comprising:
a horizontal plate; and
a pair of legs, each of which is made of a flat plate and fixed to a hoop, wherein each of the legs has a rib that is integrally formed at a center portion thereof.

3. The snare gate for a snare drum according to claim 2, wherein a rib is integrally formed on the horizontal plate.

4. A snare gate for a snare drum, comprising:
a pair of legs attached to a hoop which is fixed to an opening of a hollow cylinder of the snare drum;
a horizontal plate, which connects together both of the legs and which is arranged perpendicular to each of the legs; and
a rib which is formed on each of the legs and which is arranged perpendicular to both of the legs and the horizontal plate.
